(19) United States
(12) Patent Application Publication
(10) Pub. No.: US 2022/0107977 A1
(43) Pub. Date: Apr. 7, 2022

(54) METHODS, SYSTEMS, AND SOFTWARE FOR INSPECTION OF A STRUCTURE

(71) Applicant: Modern Adjusting Services, LLC, Diamondhead, MS (US)

(72) Inventors: Robert MARTHOUSE, Diamondhead, MS (US); Kirk LADNER, Diamondhead, MS (US); Rajani DULAL, Hattiesburg, MS (US); Hieu DUONG, Slidell, LA (US); Abhishek KC, Hattiesburg, MS (US); Thomas MOORE, Waveland, MS (US); Scott WALKER, Ocean Springs, MS (US)

(21) Appl. No.: 17/494,753

(22) Filed: Oct. 5, 2021

Related U.S. Application Data
(60) Provisional application No. 63/087,556, filed on Oct. 5, 2020.

(51) Int. Cl. G06F 16/65

(52) U.S. Cl. CPC G06F 16/65

(57) ABSTRACT

A method and system for inspecting a structure are disclosed. Data is obtained from a dimensional sensor such as a LIDAR, RGBD, or other sensor capable of collecting data in three dimensions to define a structure element or object, describing physical dimensions of a structure and its elements. A verbal description is obtained with an audio sensor. Machine learning (ML) engines identify the elements of the structure and its physical features. Audio data is parsed using NLP techniques to identify additional attributes such as the material composition of identified elements. An anomaly assessment ML engine processes the identified elements and the material composition data to determine damage or compliance status of each structure element, and financial estimation ML engine determines a financial value attributable to a structure element having the identified anomaly type(s).

### CROSS-REFERENCE TO RELATED APPLICATIONS

This application claims priority to U.S. Provisional Patent Application No. 63/087,556 filed Oct. 5, 2020, the entirety of which is herein incorporated by reference.

### BACKGROUND

### Field

Embodiments of the present disclosure generally relate to inspection of a structure or apparatus, and more particularly, to using multiple sensor types for automated structure or apparatus inspection.

### Description of the Related Art

Structure inspection is an important aspect of many industries having legal, contractual, or other requirements (e.g., safety) of a structure. Moreover, insurance companies rely on consistent and quality reporting from adjusters to remain economically viable. Consistent and quality inspections and reporting are instrumental in determining compliance with requirements, and for insurance companies, customer premium payments, and coverage amounts, that are at least in part based on actuarial data derived from inspection and damage assessment.

Estimation of damage for insurance purpose, or discovery of an anomaly in the compliance context, in a structure such as a building (e.g., homes, garages, sheds, condominiums, apartments, office buildings, retail, industrial, amusement, etc.), infrastructure (e.g., bridges, power and water transport, etc.), a vehicle such as an automobile, boat, ship, bicycle, or other vehicle and other vehicles are commonplace. When damage occurs, or an anomaly is discovered in a structure, one or more inspectors (e.g., insurance adjusters, governmental or private compliance inspector) assess the structure to estimate a cost to repair or replace the asset, and/or determine the compliance status of the structure.

In the context of insurance, an insurance adjuster inspects a building or other structure that has suffered damage and is in an unsafe condition, or the structure may still be suffering from a calamity that caused the damage. In these situations, performing a detailed inspection of the structure may be difficult or impossible without the adjuster being subject to dangerous conditions, such as damaged building supports, mold or water weakened stairs or floors, chemically contaminated vehicles, and walls on the verge of collapse, to name a few examples. Unsafe conditions for inspection can cause adjusters to be less accurate as access to vantage points needed to perform a thorough inspection is reduced or even eliminated in certain instances. This inability may be due to an actual hazard (e.g., a collapsed stairwell), or a potential hazard (e.g., a support column appears water-soaked and canted at an odd angle) that an adjuster reasonably avoids. As a result, the adjuster is unable to thoroughly assess the damaged structure.

Moreover, the quality of the adjuster's report can depend on the experience of the individual adjuster. While an experienced adjuster knows where to look and how to accurately assess damage, an inexperienced adjuster is more likely to develop a report that misses important details and/or inaccurately assesses the extent of the damage.

In either case, an inaccurate damage assessment is likely to result in substantial economic loss to the insurance company insuring the structure. Payment of coverage amounts may be inadequate to fully repair the damage, potentially resulting in additional payments to the insured that are outside of the insurance company's financial planning. Alternatively, an insured who is inadequately compensated may turn to file a lawsuit against the insurance company, resulting in additional payments to the insured, as well as significant legal fees for defense of such an action. Continually inconsistent reporting due to inexperience and/or hazardous conditions can be detrimental to an insurance company and the employees whose livelihoods depend on it.

In the context of structure compliance inspection, the experience of the inspector and conditions of inspection can cause inconsistencies and inaccuracy of inspection and the resulting reporting. This may lead to missed non-compliance issues in structures that may result in unsafe conditions, code violations, and/or potential default of contractual obligations.

What is needed in the art are methods, systems, and software for consistent and accurate inspection and analysis of structures or other apparatus.

### SUMMARY

A method and system for inspecting and detecting and assessing anomalies in a structure are disclosed. Dimensional data is obtained from a dimensional sensor such as a light detection and ranging (LIDAR) sensor, describing the physical dimensions of a structure and its elements. A verbal description of the structure and its elements is obtained with an audio sensor. Machine learning (ML) engines identify the elements of the structure and its physical features in the dimensional data. Audio data is parsed using NLP techniques to identify verbally described elements of the structure and attributes thereof, such as a material composition of identified elements. An anomaly assessment ML engine processes the identified elements and the material composition data to determine anomaly type(s) present in structure elements, and financial estimation ML engine determines a financial value attributable to a structure element having the identified anomaly type(s). Examples of anomaly type(s) include and are not limited to hail, fire, wind, water, earthquake, vandalism, exposure, wear (e.g., through normal or abnormal use), damage caused by animals, collision, abrasion, punctures, holes, or other types of damage capable of being suffered by a structure or structure element in the context of insurance, while in the context of compliance, examples include thicknesses, angles, colors, materials, element positioning, etc., that are out of compliance with legal, contractual, or other compliance requirements.

In one embodiment, a method for inspecting a structure is disclosed, the method comprising receiving first sensor data from sensing a structure element, receiving audio data comprising a verbal description of the structure element, and identifying from the first sensor data using a first trained machine learning (ML) engine, the structure element as an object type. The method further includes identifying a feature of the structure element from the first sensor data using a second trained ML engine, the feature being classified as an anomaly, classifying, using machine-based natural language processing (NLP), the audio data as describing a second feature not identified from the first sensor data of the structure element, and displaying the object type, the anomaly, and the second feature, to a user.

In another embodiment, a system for inspecting a structure is disclosed, comprising a processor, and a memory storing instructions, which, when executed by the processor perform a method for inspecting a structure. The method includes receiving first sensor data from sensing a structure element, receiving audio data comprising a verbal description of the structure element, identifying from the first sensor data using a first trained machine learning (ML) engine, the structure element as an object type. The method further includes identifying a feature of the structure element from the first sensor data using a second trained ML engine, the feature being classified as an anomaly, classifying, using machine-based natural language processing (NLP), the audio data as describing a second feature comprising a feature not identified from the first sensor data of the structure element, and displaying the object type, the anomaly, and the second feature, to a user.

In another embodiment, a system for inspecting a structure is disclosed that includes a first sensor type configured to generate first sensor data, a second sensor type configured to generate second sensor data, and a memory configure to receive the first sensor data and second sensor data. The system further includes a computer system that includes a first ML engine trained to identify a structure element of a structure based on the first sensor data, a second ML engine trained to identify a feature of the structure element, and a third ML engine trained to classify the feature as an anomaly, and trained to parse second sensor data to determine a second feature comprising a feature not identified from the first sensor data of the structure element. The system further includes a fourth ML engine trained to correlate the structure element and anomaly with a cost, and a display configured to display at least one of the structure, the structure element, the second feature, the anomaly, and the cost to a user.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 depicts a system for structure inspection according to disclosed embodiments.

FIG. 2 depicts a flow diagram for training a machine learning model according to disclosed embodiments.

FIG. 3 depicts an example flow diagram for structure anomaly assessment according to disclosed embodiments.

FIG. 4 depicts a method for structure inspection according to disclosed embodiments.

FIG. 5 depicts an example computing system for carrying out methods for structure damage assessment according to disclosed embodiments.

FIG. 6 depicts an example human-readable image generated by a LIDAR sensor system and mapping of a structure by a LIDAR sensor system.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, a reference to “the disclosure” shall not be construed as a generalization of any inventive subject matter disclosed herein and shall not be considered to be an element or limitation of the appended claims except where explicitly recited in a claim(s).

The present disclosure relates to methods and systems for inspecting structures and/or other apparatus. Data is obtained from a dimensional sensor such as a LIDAR, describing physical dimensions of a structure and its elements. In some embodiments, the dimensional sensor may be a red-green-blue-dimensional (RGBD) sensor or combination of dimensional sensors. A verbal description is obtained with an audio sensor. Machine learning (ML) engines identify the elements of the structure and their physical features. Audio data is parsed using NLP techniques to identify additional attributes such as the material composition of identified elements. An anomaly assessment ML engine processes the identified elements and the material composition data to determine anomaly type(s) to each structure element, and financial estimation ML engine determines a financial value attributable to a structure element having the identified anomaly type(s).

When an inspector (e.g., insurance adjuster, building inspector) arrives at a structure, such as a building, a vehicle, or other property, she needs to obtain detailed information on the physical state of the structure and its elements (e.g., contents and structural elements) so as to develop a report on the structure for compliance and/or damage assessment. According to methods and systems disclosed herein, the inspector deploys one or more sensors capable of collecting dimensional data on the physical dimensions and attributes of the structure. In some embodiments, this is a light detecting and ranging (LIDAR) sensor while in other embodiments a red-green-blue-dimensional (RGBD) sensor, or other sensor capable of detecting one or more points on physical features and distances of those points relative to a common point of origin and/or each other to depict dimensions of the structure and its elements (e.g., a point cloud representation), or multiple sensors with this capability. In some embodiments, additional sensor types are used, such as thermal, moisture, chemical, or other sensor types capable of sensing an attribute of a structure and/or its elements.

During the inspection with the dimensional sensors, the inspector records an audio description of the structure and its elements. The audio recording contains a description of features of structure elements that are different than, or additive to, those detected with dimensional sensors, such as color and material composition of a structure element, and may contain verbal data describing dimensional, or other attributes. The audio may also be duplicative of structure elements which are detected with dimensional sensors to enable cross-referencing and confirmation of various attributes. The inspector may choose to include additional sensor types depending on the report that needs to be generated, such as chemical sensors, radiation sensors, moisture sensors, thermal sensors, and the like.

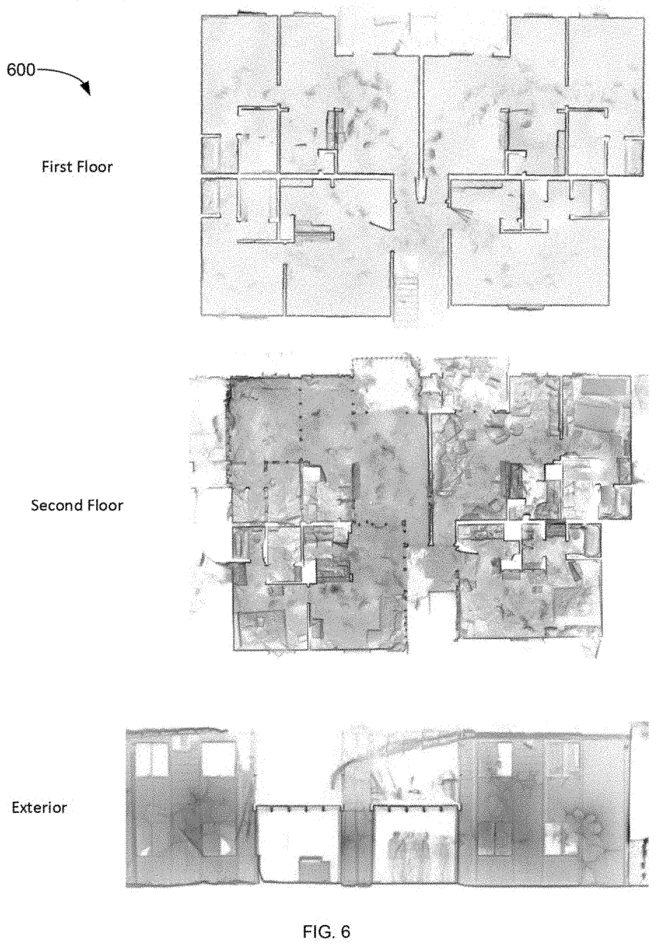

During the inspection, or after the inspector is done, the dimensional sensor data and audio data are analyzed by the disclosed methods and systems for analysis. In one embodiment, the dimensional data is used to reconstruct the structure and its elements as a computer-readable data model, and in a human-understandable format, such as depicted in FIG. 6. The data model is provided to an image processing machine learning (ML) engine to identify particular objects and/or object types, while a features/objects ML engine identifies particular features of objects. Features in this context include features that are customarily part of an identified object, as well as anomalous features not typically found on the identified object, such as damage, or in the context of compliance inspection, features indicating that a structure or structure element is in or out of compliance with a legal requirement (e.g., local, city, state, national, international building codes/requirements from private and/or public entities, materials requirements, material component requirements, and the like), contractual requirement, or industry standard. With the objects and their features identified, the result is provided to an anomaly assessment ML engine that identifies features that are damage features or features indicating a lack of compliance. This ML engine further takes the audio data, parses it to text and, using natural language processing techniques, identifies structure elements described by the adjuster in the audio data as well as additional feature data regarding identified structure elements such as color and material composition or physical makeup, attributing these features to the identified structure element.

A financial estimation ML engine takes an updated data model from the anomaly assessment ML engine and, using regression analysis, develops a data model for a structure element estimating a financial value of the identified structure element based on the value of the element itself, its material composition, and damage/non-compliance features. The output of the financial estimation ML engine is provided to a reporting module that displays the structure element, anomalous features (e.g., damage and/or non-compliant features), and financial value to a user.

Although disclosures herein describe detection and reporting on non-compliant features of a structure, it is understood that in some embodiments methods and systems disclosed herein are used to identify structure and structure elements that are in compliance. As would be appreciated by one of skill in the art, identifying both in-compliance and non-compliant features using methods and systems disclosed herein improves the speed and efficiency by which a building or other structure is inspected. Additionally, in the context of damage assessment, identifying a structure and/or structure elements that are not damaged may be carried out in alternative embodiments. In such embodiments, this may be useful in taking an inventory of a home, office, or other structure, and memorializing an undamaged state, so that an insurance company or other inspector or party better understands the scope and extent of coverage of an insured structure and its elements.

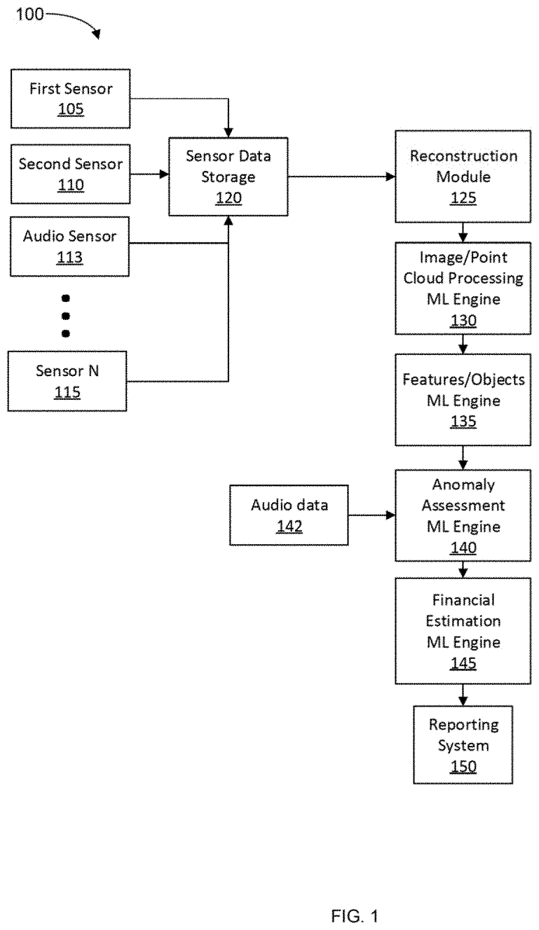

FIG. 1 depicts a system 100 for structure inspection according to disclosed embodiments for damage, compliance, or elements of each of these. In this context, a structure is understood to be any type of structure capable of being inspected for damage and/or compliance with legal, contractual, or other (e.g., safety) requirements. One of skill in the art understands this may be any free-standing structure such as a single building, home, office building, retail or industrial building, or group of structures such as a group of stores in a mall, an apartment complex, or other adjacent buildings whether structurally interconnected or not. A structure typically includes walls, columns, supports, roofs, or other elements that are components of buildings or other structures, and may include the contents as well. A structure in this context is not limited to buildings or their elements and should be understood to include any structure, including modern infrastructure such as bridges, piers, tunnels, freeways, roads, and the like, including resource generation and transportation infrastructure such as dams, pipes, and power generation instrumentalities. Moreover, a structure may include non-stationary structures such as vehicles, whether intended for travel on land, sea, air, or in space. Any structure in this context that may be insurable or inspected is to be included, as well as any component or portion thereof, referred to herein as a structure element. Additionally, a structure may include an object or other chattel that may be covered by insurance and subject to inspection, as a structure element. A structure element may be a component, content, or aggregation of components and/or contents, of a structure.

System 100 includes a first sensor 105, a second sensor 110, and any number of additional sensors up to sensor N 115. One or more of sensors 105 through sensor N115 are carried by a user as separate devices or are aggregated in one or more multi-sensor devices for convenience. In some embodiments, a user carries one or more sensors in a body-mounted system or mounted on an extensible device such as a pole or a cable (e.g., a borescope, flexible camera inspection snake, or the like), to enable access to hard-to-reach spaces. In other embodiments, one or more sensors are mounted in a robotic device, a drone, carried by another user or a trained animal. In some embodiments, one or more sensors are placed in a stationary position about a structure to acquire sensor data and moved between stationary locations.

In embodiments, the first sensor 105 may be a light detecting and ranging (LIDAR) sensor, according to certain embodiments. In other embodiments, the first sensor 105 is of a different type such as other sensor types disclosed herein, such as an RGBD sensor. LIDAR sensors operate to project a plurality of laser signals onto surfaces of a structure and its structure elements (e.g., walls, supports, cabinets, entryways, windows, structure contents such as furniture and/or other items or chattels, etc.), to return data (e.g., point cloud data) indicating distance and directional measurements of the structure elements and physical features thereof at high resolutions. Because LIDAR sensors can be configured to project many (e.g., millions or more) laser signals onto the surfaces of the structure and its elements, these sensors create very detailed dimensional information (length, width, depth) of a structure and its elements, capable of developing data depicting the physical nature and state of a structure and its elements. Because of the detailed nature of the data provided by a LIDAR sensor, attribute data regarding minute anomalies can be developed, capable of indicating anomalies, by way of example, holes, warped surfaces, creases/cracks/crevices, and/or attributes that can indicate compliance with requirements, in structure elements. In addition to providing data regarding anomalies, a LIDAR sensor develops data describing attributes of these anomalies such as depth/height/width, size and shape of an anomaly (e.g., of a hole or crack, or an item protruding from a surface), angles (e.g., of a damaged or out of alignment wall, support, staircase, or the like), in addition to aggregating this data to provide a user with two or three dimensional (3D) human-readable mapping of the structure. Moreover, by taking advantage of reflectance values of materials, one of skill in the art may further utilize LIDAR to determine the material composition of surfaces scanned by a LIDAR sensor. By utilizing mapping capabilities, the first sensor determines the location and physical attributes of structure elements within a map of the structure. An example of a structure mapped by a LIDAR sensor in a human-readable format is depicted in FIG. 6. As can be appreciated, more detailed data may be obtained by placing the LIDAR sensor in closer proximity to individual structure elements. In other embodiments, first sensor 105 may be a camera, video capture device, or other sensor capable of detecting three dimensional data, such as a red-green-blue-depth (RGBD) sensor, or other sensor capable of providing depth data (e.g., z-axis data) on imaged elements, in addition to x-axis and y-axis position data.

A second sensor 110 is provided to augment the data provided by the first sensor. The second sensor 110 in this context provides similar/same data as first sensor 105 and or data that not easily collectible by the first sensor 105. In embodiments, the second sensor 110 may be a red-green-blue-depth (RGBD) sensor such as a camera or video recording device capable of capturing depth data, which in some embodiments, has a 360-degree field of view. According to certain embodiments, second sensor 110 may be a laser scanner that is capable of developing depth data for scanned elements. In one embodiment, the second sensor 110 is a plurality of sensors. In yet further embodiments, the first sensor 105 and the second sensor 110 are provided in the same physical device, enabling a user to easily record physical attributes and anomalies of a structure under examination. While the first sensor 105 gathers LIDAR data, the second sensor 110 collects RGBD and/or image data, including depth data utilized by machine learning engines (discussed below) to map structure elements and detect anomalies thereof, as well as provide additional information on identified anomalies and structure elements.

Examples of cameras and scanners that may be employed for one or both of first sensor 105 and second sensor 110 include and are not limited to REALSENSE by INTEL CORPORATION, KINECT by MICROSOFT CORPORATION, ZED by STEREOLABS CORPORATION, BLK2GO by LEICA GEOSYSTEMS CORPORATION, ZEB HORIZON by GEOSLAM CORPORATION, FOCUS SWIFT by FARO CORPORATION, and STENCIL PRO by KAARTA CORPORATION.

For example, while the first sensor 105 gathers data indicating that a wall has a lateral buckle along its width, indicating the wall has suffered some damage or is out of compliance, the second sensor 110 gathers data showing a discoloration of the wall up to the buckle, indicating water damage. Together, the data from the first and second sensors indicate flood damage (from the discoloration) and the type of damage (wall buckle). In another example, while the first sensor 105 indicates that a portion of a structure is a kitchen counter, the second sensor 110 indicates that the countertop is a wooden counter. Data from both sensors is utilized by a user to assess the financial impact of damage to the kitchen of the structure.

An audio sensor 113 is provided for a user of the system 100 to provide a descriptive narrative as an additional source of data describing the structure and structure elements. In embodiments, other sensors such as the first sensor 105, second sensor 110, or other sensors may not be able to accurately capture data depicting the material makeup of a structure or structure element, the user may verbally describe the structure, one or more structure elements, the material from which these are constructed, physical dimensions, anomalies, physical condition, and other attributes. As will be discussed below, the verbal description data captured by the audio sensor 113 is used by the system 100 for describing the structure and/or its elements to more accurately assess damage and/or compliance status.

In some embodiments, the system 100 is further equipped with additional sensors, such as a sensor N 115. Sensor N 115 is any other type of sensor useful to a user of the system 100 in assessing the damage of a structure. By way of example and not limitation, the additional sensors include a thermal/infrared sensor, ultraviolet sensor, moisture sensor, humidity sensor, vibration sensor, distance sensor, motion sensor, chemical sensor, radon sensor, CO2 sensor, CO sensor, molecular analyzer, radar, sonar, acoustic sensor, fire detector/sensor, tone generator, video camera, still camera, or any other sensor type useful for recording data regarding a structure and/or its elements.

The sensors 105, 110, 113, and 115 are coupled to and in communication with a sensor data storage 120, to which each sensor provides its data for further use and analysis. In some embodiments, the sensors are directly coupled to the sensor data storage 120, while in other embodiments, the sensors are coupled to an intermediary device (e.g., a mobile phone, laptop, tablet, or other devices capable of receiving sensor data and providing it to sensor data storage 120) that in turn provides data from the sensors to the sensor data storage 120. In yet further embodiments, one or more sensors may be directly coupled to the components of system 100 that will utilize the data generated by the sensors, potentially removing the need for sensor data storage 120.

In some embodiments, sensor data storage 120 is a data storage device on a computer or other computing device such as a phone or tablet or a dedicated storage device such as a network-attached storage (NAS) or portable data storage device. In other embodiments, sensor data storage 120 includes a cloud storage device.

System 100 further includes a reconstruction module 125 that develops a data representation of the structure and/or structure elements from one or more of sensors 100-115. In some embodiments, data from sensors capable of collecting data depicting physical features and attributes of the structure and/or its elements, such as LIDAR and RGBD type sensors, are utilized by reconstruction module 125 for the development of the data representation, that may include a visual depiction of the structure and its elements (e.g., such as depicted in FIG. 6). In embodiments where data from more than one sensor capable of collecting dimensional and depth data are used, reference data points from data of each sensor type are used to correlate both data sets to a single 3D data model and/or visual representation.

Image/point cloud processing ML engine 130 receives the data from the reconstruction module 125 to identify one or more structure elements and/or physical attributes of each element, as objects. The received data is used to generate a point cloud model data or 3D image model data of the imaged/scanned structures, structural elements, and/or physical objects. An ‘object’ is any physical object that may be found in or be part of a structure or structure element. The image/point cloud processing ML engine 130 generates point cloud and/or 3D image data of objects and structures imaged by one or more the sensors (e.g., first sensor 105 through sensor N 115).

Once point cloud and/or 3D image data representing the structure elements have been identified by image/point cloud processing ML engine 130, this data is provided to a feature/objects ML engine 135 for further processing. The feature/objects ML engine 135 identifies features of each identified structure element as a discrete object type (e.g., table, wall, ceiling beam, doorway, light fixture, appliance, power switch, etc.) to what type of object the structure element is, and in some embodiments, the make and model of the object type. By way of example, features/objects ML engine 135 identifies a structure element as a particular type, such as a stair, bannister, countertop, television, easy chair, etc., by employing a trained machine learning engine to compare data provided by image/point cloud processing ML engine 130 to a template library of identified object templates. According to certain embodiments, a template may be of an object type (e.g., chair, wall, window, automobile steering wheel, etc.), and in some embodiments a template may be of a particular make or model of an object type (e.g., a refrigerator of a particular make and model, a particular model of dining table from a particular manufacturer, a staircase of a particular designer, etc.). According to certain embodiments, features/objects ML engine 135 includes a RandLA-Net machine learning architecture for segmenting point cloud data provided by image/point cloud processing ML engine 130. An embodiment of RandLA-Net machine learning architecture may be found at https://arxiv.org/pdf/1911.11236.pdf. For embodiments in which image/point cloud processing ML engine 130 provides depth-enhanced visual data, features/objects ML engine 135 may further employ a You Only Look Once (YOLO), such as YOLOv4 architecture, a description of embodiments of which may be found at https://jonathan-hui.medium.com/yolov4-c9901eaa8e61. Identifying anomalies such as, protrusions, gaps, splits, holes, features indicating compliance/lack of compliance, and other physical features of a structure element is accomplished by classification and/or object detection machine-learning techniques.

According to certain embodiments, a semantic segmentation machine learning technique is used for by features/objects ML engine 135 this purpose, while in other embodiments, object detection or instance segmentation are used. In other embodiments, more than one of these techniques may be utilized. One of skill in the art will appreciate that any machine learning technique capable of identifying distinct objects, either individually or as members of categories of objects, may be utilized.

For embodiments utilizing semantic segmentation, deep learning model architectures are utilized to implement the technique. For example, fully convolutional networks, U-net architectures, mask RCNN architectures, or other deep learning architecture are utilized, including combinations of these. Other architectures suitable for implementing semantic segmentation include 3DShapeNets, VoxNet (3D convolutional neural network), SubVolume, multi-view convolutional neural network (MVCNN), PointNet, PointNet++, SpecGCN (local spectral graph convolution), dynamic graph convolutional neural network (DGCNN), and PointWeb.

Training a data set for the feature/objects ML engine 135 is provided similarly to that of the image/point cloud processing ML engine 130. According to certain embodiments, the training data provided for features/objects ML engine 135 comprises template images of known and labeled object types, with labeled features of labeled objects. Known and labeled image data are provided, and a larger training data set is developed by programmatically transforming one or more features of the training data. In some embodiments, training data is transformed or otherwise modified to create a larger, more robust, training data set. For example, an image of a structural support element such as a column is modified to blur, add skew, speckles, change the contrast, or otherwise mutate the image about the portion of the image rendering the crack, to create different permutations of the cracked column. In some embodiments, a user specifies features of image data and how that data is to be modified, such that additional images are created in which all of the specified features are modified. Sources of training data may be and are not limited to, historical data from previous incidents, synthetic data, simulated data, or a combination of two or more of these.

System 100 further includes an anomaly assessment ML engine 140 that receives structure element data that has been identified as being of a particular type (e.g., chair, countertop, window, wall stud, structural beam, automobile dashboard, etc.) for each identified object by features/objects ML engine 135. Using identified objects data from the features/objects ML engine 135, the anomaly assessment ML engine 140 uses classification and/or object detection techniques to classify object features as anomalous or non-anomalous features. A feature classified as anomalous in embodiments could be detected features of a structure element that were not part of the structure element in its original, or new, form, such as damage and/or in the context of compliance inspection, features indicating a lack of compliance with requirements. Detected anomalies are classified as such, and in certain embodiments are further classified based on type of damage (e.g., water damage, crack, missing, rusted, crushed, etc.), or in the context of compliance, classified as being in compliance or out of compliance, depending on the standard or regulation being classified against.

In addition to detecting the type of anomaly, the extent or magnitude of effect of the anomaly is detected as well. Extent or magnitude of effect of anomaly may be, for example, the dimensions of an area affected (e.g., on a wall, floor, ceiling, object, etc.) by the anomaly. By way of example and not limitation, for flood damage, a waterline on a wall may be detected as damage, in addition to the dimensions (e.g., height of waterline, square feet, yards, etc. affected by the water), mold damage may be detected, as well as size of mold patch(es), and water stains, and their dimensions, may be detected. For fire damage, smoke, soot, and singe discoloration may be detected and classified as damage, and the dimensions of area affected by these may be detected, as well as holes or other structural damage caused by fire, and the dimensions of such damage. For wind damage, damaged building siding, roof damage, damaged building materials, broken windows, fallen trees (and damage caused by fallen trees) may be detected and classified. Automobile damage may be detected and classified (e.g., crumpled auto body portions, bent frames and axles, broken windows, damaged upholstery, etc.), as well as detection of area of effect of such damage. In the context of compliance, detected wiring, placement of fixture outlets, use of support structures, etc., may be anomalous (e.g., out of compliance) for failure to comply with building codes.

According to certain embodiments, systems disclosed herein may be used to record a current state of an object, vehicle, building, and/or building components, at the outset of a new insurance policy. In this context, images/point clouds of the objects and buildings may stored as templates of non-anomalous condition of these items, against which futures scans may be compared for insurance purposes.

An anomaly in this context of damage inspection, for example, may be a crack in a window pane, a dent in a filing cabinet, half of a light fixture, a broken step of a staircase, collapsed wall, dented fender, broken cabinet, water damaged drywall, deceased animals, etc., or other damage of a structure or structure element of any type. In the context of compliance inspection, an anomaly may include, for example, structure elements that are out of required measurement tolerances, out of alignment, incorrect materials, missing, and/or additional structure elements that do not belong in the structure. Data depicting an object and its features may be updated to the extent an identified feature is classified as an anomaly. Moreover, features classified as anomalous may also be identified as a particular type of damage or missing of compliance requirements in the identified structure element.

Training a data set for the anomaly assessment ML engine 140 is provided similarly to that of the image/point cloud processing ML engine 130. By way of example, damaged versions of image and/or object templates used for training features/objects ML engine 135 may be employed for training, as well as templates depicting damage types to depicted objects. In this context, damage is labeled as being of a particular type. For example, an image depicting a wall having a waterline may be labeled to indicate flooding; a broken window labeled as such; a bowed staircase having one or more labels reflecting the damage (e.g., being bowed). Known and labeled image data are provided, and a larger training data set is developed by programmatically transforming one or more features of the training data. In the context of requirements compliance, training data may include required attributes (e.g., measurements, materials, placement, prohibited elements, required elements, placement requirements) that may be entered directly into the system, scanned from requirements documents, or from data (e.g., dimensional data such as point cloud data, images, audio description) from structures and structure elements that may be labeled as to their compliance status—in compliance or out of compliance, depending on the training data images/objects of the desired training.

Anomaly assessment ML engine 140 further receives input audio data 142, such as from audio sensor 113. In embodiments, the audio data 142 is a voice recording of a user (e.g., an insurance adjuster, building inspector, engineering inspector) describing a structure and/or structure elements. Speech from the voice recording is transcribed to text, and keywords are extracted from the text. In embodiments, one or more natural language processing (NLP) ML techniques are used to identify structure elements described in the audio from the text. Examples of such ML techniques include one or more of word2vec, doc2vec, Glove, RandSet, keyword detection that utilizes one or more of a standard convolutional neural network (CNN), depthwise separable CNN (DS_CNN), or other NLP ML techniques or model architectures capable of identifying words or phrases in text or speech. Such ML techniques are carried out on a neural network architecture such as a recurrent neural network, feed-forward neural network, feedback neural network, or other suitable architecture. Once audio data 142 from audio sensor 113 is processed, it is correlated to the image and feature data to provide additional detail. For example, because neither LIDAR nor RGBD sensor data are designed to accurately sense object colors and/or material composition, the system 100 may rely on audio data 142 for this information. For example, when an inspector describes a kitchen countertop as “wood end-grain butcher block,” an office filing cabinet as “sheet metal,” a painting as “an original Picasso,” a pipe as having “inconsistent joint welds,” or a wall as having “water damage at approximately 6′ up from the floor”, after NLP processing and identification of these additional details, such details are added to the structure element image and feature data, to be used in determining the object type, damage type, and as discussed below, the financial value of an identified anomaly of a structure and/or structure elements.

As above, damage assessment ML engine 140 is trained using existing labeled data designed for training, and such data is automatically modified so as to provide more robust training data sets.

System 100 further includes a financial estimation ML engine 145 that receives structure element object data, feature data (including material composition), and identification of features that are classified as anomalous features. By using the structure element object type identified by the image/point cloud processing ML engine 130 and the anomaly feature classification from anomaly assessment ML engine 140, the financial estimation ML engine 140 determines the financial value of identified anomalies to a given structure element. In embodiments, a regression ML technique is utilized, while in other embodiments, one or more databases are used (e.g., queried) to obtain financial values based on structure element object data, feature data, and identification of anomalous features, once data sets containing these attributes have been developed, to determine the financial value. As is understood by one of ordinary skill, the value of an anomaly of a structure or structure element may be based on a variety of standards, such as the cost to repair or cost to replace the anomalous structure element.

As with other ML engine system disclosed herein, financial estimation ML engine 145 is trained prior to use with data from a structure using historical, synthetic, simulated, and/or transformed data. In this context, the training data includes images of structure elements labeled with an undamaged financial value and a damaged financial value, based at least in part on an identified damage type and magnitude, as well as costs of replacement (e.g., cost of new item and/or cost of labor to remove and replace with another) and/or repair (e.g., from repair schedules, material costs, labor costs). In the context of requirements compliance, financial estimation is based on the cost to repair or replace an out of compliance structure/structure element, such as repair schedules, parts costs, labor costs, etc. System 100 further includes a reporting system 150 that receives financial estimation data from financial estimation ML engine 145. The reporting system 150 processes financial estimation data to develop a human-readable format for information describing the anomaly of the structure/structure element and its financial impact for reporting. In one embodiment, the reporting system 150 provides this information to a third party reporting package such as XACTIMATE™ by Xactware Solutions of Lehi, Utah for reporting and further processing. In other embodiments, the financial estimation data is not transformed to a human-readable format and maintained in a database, for example, and used as training data for one or more of the ML engines disclosed herein, and/or as data for studies related to structures, damage assessment, compliance assessment, and the like.

In further embodiments, a report is one or more images, with anomalous portions (e.g., damaged and/or out of compliance) structures/structure elements highlighted. In these embodiments, features of structure elements determined to be anomalous are highlighted (e.g., encircled, outlined, or otherwise highlighted with a semi-transparent color layer on the structure element feature at issue). Reporting provided with images may also be provided via video, either in real-time or recorded for future viewing. Accordingly, this enables the user of methods and systems disclosed herein to perform an in-person scanning of a structure and its elements, while another user (e.g., experienced insurance adjuster and/or compliance inspector) views the report remotely from the user. In some embodiments, methods and systems include verbal communication between two users so that a remote user may direct a user at an inspection site to features of interest.

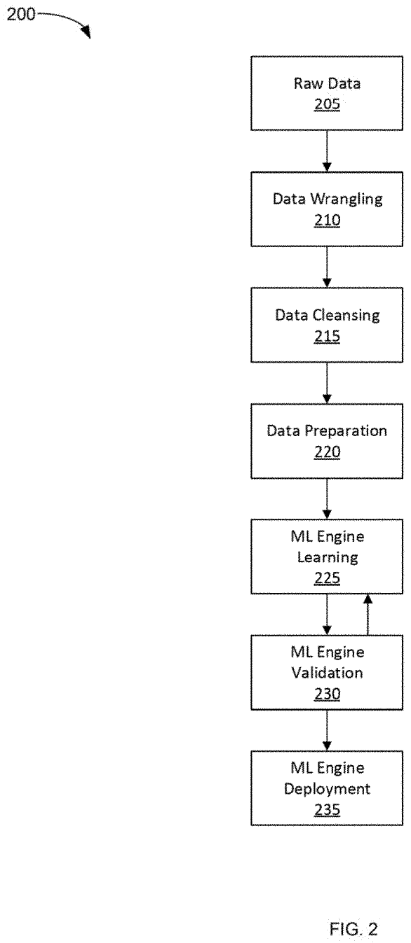

FIG. 2 depicts a flow diagram 200 for training a machine learning model according to disclosed embodiments.

At operation 205, raw data is received for training a machine learning model, which may be similar to one or more of the image/point cloud processing ML engine 130, the features/objects ML engine 135, anomaly assessment ML engine 140, and/or financial estimation ML engine 145. Raw data is of a similar type utilized to train the machine learning model, such as LIDAR data, RGBD data, audio, infrared (IR), thermal, chemical, etc., as contemplated herein. Raw data is acquired directly from sensors or may be historic data, synthesized data, or simulated data.

At operation 210, the raw data is converted to a normalized format. As is understood by one of skill in the art, it is not unusual that data for use in training a machine learning model is received in a form that is not ready to be provided for training to an ML engine. At this block of the flow diagram 200, the raw data is converted to a format for training the ML engine. Conversion in this context may include parsing the data into an appropriate format (e.g., JSON, XML, CSV), adding fields for ML engine training (e.g., labels, features), removing fields not used by the ML engine, developing a schema for the data, or other actions for making the raw data ready for consumption by a machine learning model.

At operation 215, the data is cleansed, which may include removing noisy data elements (e.g., contain incorrect and/or erroneous data), removing duplicates, removing information that may not be appropriate for the machine learning model (e.g., personally identifiable information).

At operation 220, the converted and cleansed raw data is prepared for input to train the ML engine. In some embodiments, this includes transforming the data so as to create larger and more varied data sets for training. Transforming in this context may include resampling the data, augmenting the data, and/or transforming the data through the addition of noise, skew, changing contrast, speckling, or other transformation, or the data, or other algorithmically applied modification of the data to change data elements, or develop copies of data elements, that are different than the originally provided data. For example, blurring a visual element of the data, changing colors, and/or applying visual skew to the data can result in a larger data set that will result in a more robust trained ML engine.

Additionally, at operation 220, the provided data is labeled for training the ML engine. Data elements that are transformed or augmented versions of the provided data are also labeled.

At operation 225, the prepared data is provided to train the ML engine. Operation 225 is performed iteratively with operation 230 via ML engine validation that provides feedback to the ML engine learning of operation 225.

At operation 235, the trained ML engine is deployed, for example, as at least one of image/point cloud processing ML engine 130, features/objects ML engine 135, anomaly assessment ML engine 140, and/or financial estimation ML engine 145 of FIG. 1.

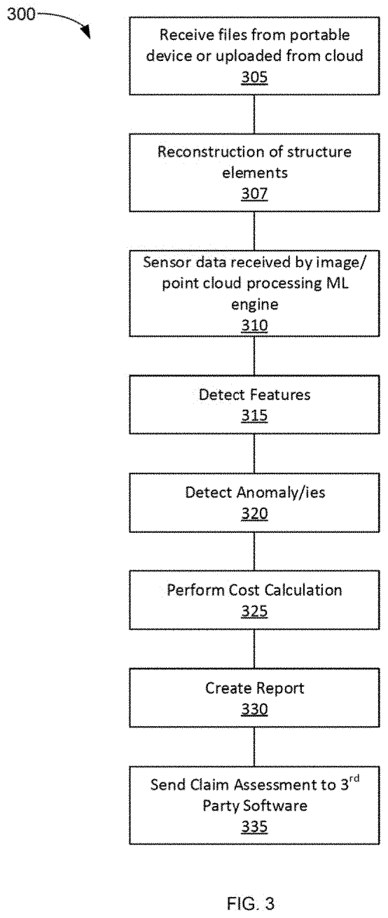

FIG. 3 depicts an example flow diagram 300 for structural damage assessment according to disclosed embodiments.

At operation 305, data is received from sensors such as first sensor 105 through sensor N 115 of FIG. 1, either directly, from a portable device that collects data from sensors, or from another data storage such as cloud storage, dedicated storage device, or computing device capable of storing sensor data. At operation 307, the data from one or more of the sensors are used to model structure elements for a structure with the sensor data by a reconstruction module such as 3D reconstruction module 125. In embodiments, data from multiple sensors are used for reconstruction. At operation 310, the sensor data and/or reconstruction data is received by an image/point cloud processing ML engine, such as image/point cloud processing ML engine 130, where one or more individual structure elements are identified and then classified as a particular object type or as a member of a group of objects of a particular type.

At operation 315, one or more features of objects identified at operation 310 are detected in the sensor data using one or more of ML engines, such as feature/objects ML engine 135 of FIG. 1 that identifies features of structure elements.

At operation 320, one or more features are identified and/or classified as anomalous features of the structure element. In this context, an anomaly is a feature of a structure or structure element identified as damaged or as non-compliant. According to certain embodiments, structures and/or objects may be compared to non-anomalous images/templates in order to determine anomalous features. In embodiments where an assessment of physical structures and/or goods as being ascertained as part of developing a new insurance policy, features and objects may be recorded at this operation as being in an undamaged state without anomalies.

At operation 325, features identified as anomalous features are used, together with the object type of the structure element, to develop an anomaly assessment, using an ML engine such as anomaly assessment ML engine 140. In embodiments, this assessment is augmented with audio data comprising a verbal description of the structure element, for example, to provide information describing a second feature, for example, the material making up the structure elements, color information, and the like, that may not be provided by other sensors, such as sensors 105-115 of FIG. 1. Further, a financial estimation of the damage or non-compliance assessed is developed, for example, using financial estimation ML engine 145 of FIG. 1, to determine the financial value of the damage or non-compliance of the one or more structure elements.

At operation 330, a human-readable report is developed that includes structure, structure elements, anomaly descriptions to respective structure elements, highlighting structure elements having an anomaly, and/or financial estimation for the cost of described damage or non-compliance. In some embodiments, the report is text-based, image-based, or a combination of text and images. Other embodiments include video generated in real-time or recorded for later use.

At operation 335, the human-readable report is provided to claim assessment software, such as XACTIMATE, developed by Xactware Inc., or other claim assessment or compliance reporting software. The elements of the report are parsed and provided to the appropriate fields of the claim assessment software. By way of example, damage, or compliance status, is determined as disclosed by methods and systems herein. As discussed elsewhere herein, a damage type is determined (e.g., hail, fire, flooding, earthquake, etc.) while in the context of compliance status, structure dimensions, status of a structure and or structure elements, placement and/or number of particular structure elements (e.g., number of doors, windows, outlets; thickness, location, material composition or design of load-bearing elements; etc.), and a report generated therefrom, in machine and human-readable forms.

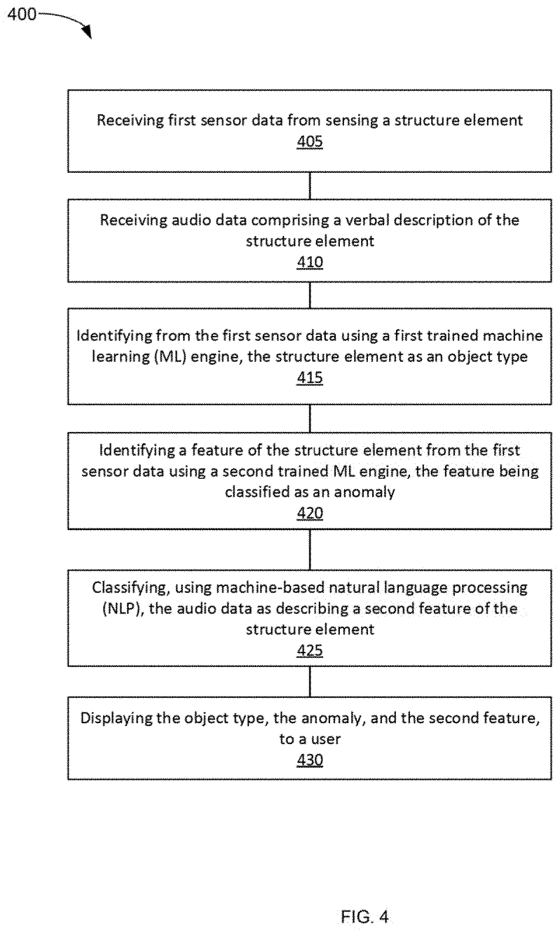

FIG. 4 depicts a method 400 for identifying an anomaly to a structure or structure element, according to disclosed embodiments. At operation 405, the method 400 receives first sensor data from sensing a structure element. In some embodiments, the first sensor is a light detection and ranging (LIDAR) sensor. At operation 410, the method 400 receives audio data comprising a verbal description of the structure element.

At operation 415, the method 400 identifies, from the first sensor data using a first trained machine learning (ML) engine, the structure element as an object type.

At operation 420, from the first sensor data using a second trained ML engine, a feature of the structure element is identified and classified as an anomaly, while at operation 425 using machine-based natural language processing (NLP), the audio data is classified as describing a second feature such as a material composition of the structure element. In some embodiments, the machine-based NLP includes converting speech to text, parsing the text to identify keywords correlating to the structure element, and identifying the second feature in the context of the identified keywords. In further embodiments, machine-based NLP may further include analyzing the text using one of Word2Vec, Doc2Vec, Glove, and RandSet.

In some embodiments, training one of the first trained ML engine and second trained ML engine includes receiving labeled data comprising one of real-time data, historical data, synthetic data, and simulated data, and training the one of the first trained ML engine and second trained ML engine using the labeled data. In some embodiments, the labeled data includes transforming the labeled data by one of skew, contrast, speckling, de-speckling, and blur, and providing the transformed labeled data to train the one of the first trained ML engine and second trained ML engine.

At operation 430, the method 400 displays the object type, the anomaly, and the second feature composition to a user.

In some embodiments, the method 400 also includes receiving second sensor data from sensing the structure element and identifying the structure element using second sensor data. In some embodiments, the second sensor is a red-green-blue-depth (RGBD) sensor.

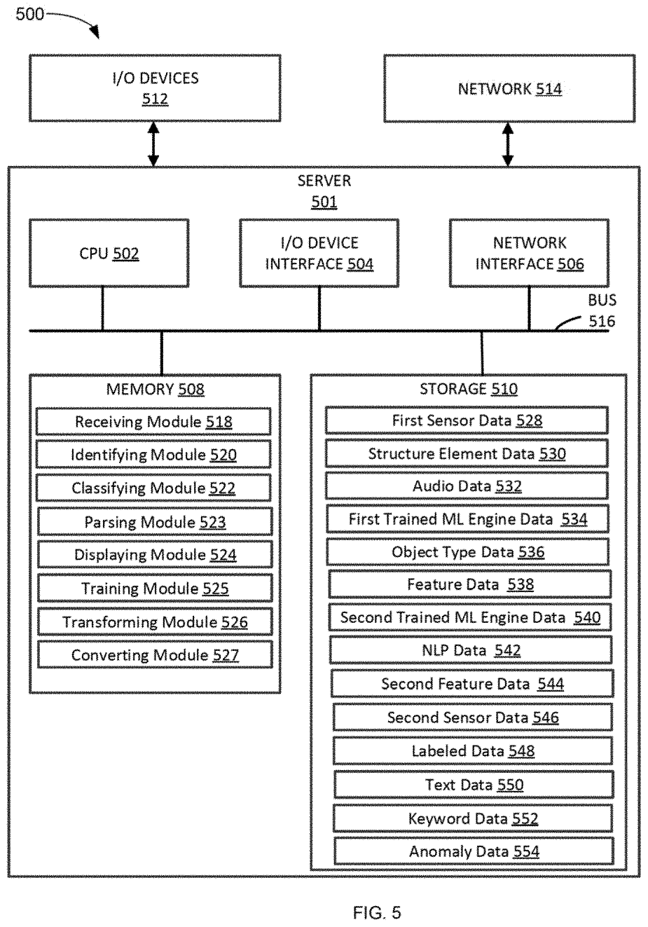

FIG. 5 depicts an example computing system 500 according to disclosed embodiments that perform methods described herein, such as providing structure anomaly analysis described with respect to FIGS. 1-4.

Server 501 includes a central processing unit (CPU) 502 connected to a data bus 516. CPU 502 is configured to process computer-executable instructions, e.g., stored in memory 508 or storage 510, and to cause the server 501 to perform methods described herein, for example, with respect to FIGS. 2-4. CPU 502 is included to be representative of a single CPU, multiple CPUs, a single CPU having multiple processing cores, and other forms of processing architecture capable of executing computer-executable instructions. Moreover, although server 501 is represented as a single system, it is understood that server 501 may include one or more physical or virtual computer systems.

Server 501 further includes input/output (I/O) device(s) 512 and interfaces 504, which enable the server 501 to interface with input/output devices 512, such as, for example, keyboards, displays, mouse devices, pen input, sensor devices, and other devices that enable interaction with the server 501. It is to be understood that the server 501 may connect with external I/O devices through physical and wireless connections (e.g., an external display device).

Server 501 further includes a network interface 506, which provides the server 501 with access to an external network 514 and thereby external computing devices.

Server 501 further includes the memory 508, which in this example includes a receiving module 518, an identifying module 520, a classifying module 522, a parsing module 523, a displaying module 524, a training module 525, a transforming module 526, and a converting module 527 for performing operations described in FIGS. 2-4.

Note that while shown as a single memory 508 in FIG. 5 for simplicity, the various aspects stored in memory 508 may be stored in different physical and/or virtual memories, including memories remote from server 501, but all accessible by CPU 502 via internal data connections such as the bus 516.

Storage 510 further includes first sensor data 528, structure element data 530, audio data 532, first trained ML engine data 534, object type data 536, feature data 538, second trained ML engine data 540, NLP data 542, second feature data 544, second sensor data 546, labeled data 548, text data 550, keyword data 552, and anomaly data 554 as described in connection with FIGS. 2-4. While not depicted in FIG. 5, other aspects may be included in storage 510.

As with memory 508, a single storage 510 is depicted in FIG. 5 for simplicity, but various aspects stored in storage 510 may be stored in different physical storages, but all accessible to CPU 502 via internal data connections, such as bus 516 or external connection, such as network interfaces 506. One of skill in the art will appreciate that one or more elements of the server 501 may be located remotely and accessed via a network 514.

By employing methods and systems disclosed herein, an insurance adjuster can automatically obtain large amounts of accurate data on a damaged or non-compliant structure while increasing her safety during an inspection. For example, an adjuster need only walk through a structure to gather data with sensors, relying on sensors to gather data on finer details of an inspection site. In situations where additional detail is desired, and access is limited, sensors may be mounted on a pole, drone, robotic device, or other assisting mechanisms, to position the sensors within or in close proximity to the structure for closer inspection.

Moreover, because the detected anomaly is identified, classified, and financially assessed in an automated fashion by machine learning engines that grow increasingly accurate as more data is consumed, insurance claims reports can become more consistent. As machine learning models disclosed herein and adapted for use with disclosed embodiments become increasingly accurate by being trained on an ever-larger corpus of data, so will the accuracy and consistency of classification and reporting. Accordingly, even an inexperienced inspector will be able to develop consistent, thorough, and detailed reports on damaged and/or non-compliant structures, or provide the same to an experienced inspector in real-time.

While the foregoing is directed to embodiments of the present disclosure, other and further embodiments of the disclosure may be devised without departing from the basic scope thereof, and the scope thereof is determined by the claims that follow. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more operations or actions for achieving the methods. The method operations and/or actions may be interchanged with one another without departing from the scope of the claims. In other words, unless a specific order of operations or actions is specified, the order and/or use of specific operations and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the Figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for inspecting a structure comprising:
receiving first sensor data from sensing a structure element;
receiving audio data comprising a verbal description of the structure element;
identifying from the first sensor data using a first trained machine learning (ML) engine, the structure element as an object type;
identifying a feature of the structure element from the first sensor data using a second trained ML engine, the feature being classified as an anomaly;
classifying, using machine-based natural language processing (NLP), the audio data as describing a second feature not identified from the first sensor data of the structure element; and
displaying the object type, the anomaly, and the second feature, to a user.

2. The method of claim 1, further comprising:
receiving second sensor data from sensing the structure element, and wherein identifying the structure element further comprises using the second sensor data.

3. The method of claim 2, wherein the first sensor is a light detection and ranging (LIDAR) sensor, and the second sensor is a red green blue depth (RGBD) sensor.

4. The method of claim 1, wherein training one of the first trained ML engine and second trained ML engine comprises:
receiving labeled data comprising one of real time data, historical data, synthetic data, and simulated data; and
training the one of the first trained ML engine and second trained ML engine using the labeled data.

5. The method of claim 4, wherein the labeled data comprises:
transforming the labeled data by one of skew, contrast, speckling, de-speckling, and blur; and
providing the transformed labeled data to train the one of the first trained ML engine and second trained ML engine.

6. The method of claim 1, wherein the machine based NLP comprises:
converting speech to text;
parsing the text to identify keywords correlating to the structure element; and
identifying the second feature in a context of the identified keywords.

7. The method of claim 6, further comprising:
analyzing the text using one of Word2Vec, Doc2Vec, Glove, and RandSet.

8. A system for inspecting a structure comprising:
a processor; and
a memory storing instructions, which, when executed by the processor perform a method comprising:
receiving first sensor data from sensing a structure element;
receiving audio data comprising a verbal description of the structure element;
identifying from the first sensor data using a first trained machine learning (ML) engine, the structure element as an object type;
identifying a feature of the structure element from the first sensor data using a second trained ML engine, the feature being classified as an anomaly;
classifying, using machine-based natural language processing (NLP), the audio data as describing a second feature comprising a feature not identified from the first sensor data of the structure element; and
displaying the object type, the anomaly, and the second feature to a user.

9. The system of claim 8, further comprising:
receiving second sensor data from sensing the structure element, and wherein identifying the structure element further comprises using the second sensor data.

10. The system of claim 9, wherein the first sensor is a light detection and ranging (LIDAR) sensor, and the second sensor is a red green blue depth (RGBD) sensor.

11. The system of claim 8, wherein training one of the first trained ML engine and second trained ML engine comprises:
receiving labeled data comprising one of real time data, historical data, synthetic data, and simulated data; and
training the one of the first trained ML engine and second trained ML engine using the labeled data.

12. The system of claim 11, wherein the labeled data comprises:
transforming the labeled data by one of skew, contrast, speckling, de-speckling, and blur; and
providing the transformed labeled data to train the one of the first trained ML engine and second trained ML engine.

13. The system of claim 8, wherein the machine based NLP comprises:
converting speech to text;
parsing the text to identify keywords correlating to the structure element; and
identifying the second feature in a context of the identified keywords.

14. The system of claim 13, further comprising:
analyzing the text using one of Word2Vec, Doc2Vec, Glove, and RandSet.

15. A system for inspecting a structure, comprising:
a first sensor type configured to generate first sensor data;
a second sensor type configured to generate second sensor data;
a memory configure to receive the first sensor data and second sensor data; and
a computer system, comprising:
a first ML engine trained to identify a structure element of a structure based on the first sensor data;
a second ML engine trained to identify a feature of the structure element;
a third ML engine trained to classify the feature as an anomaly, and trained to parse second sensor data to determine a second feature comprising a feature not identified from the first sensor data of the structure element;
a fourth ML engine trained to correlate the structure element and anomaly with a cost; and
a display configured to display at least one of the structure, the structure element, the second feature, the anomaly, and the cost to a user.

16. The system of claim 15, wherein the first sensor type and second sensor type are different.

17. The system of claim 16, wherein the first sensor type is a LIDAR sensor, and the second sensor type is an audio sensor.

18. The system of claim 15, further comprising:
a third sensor type configured to generate third sensor data, the third sensor type being different from the first sensor type and second sensor type, wherein the first ML engine is trained to identify the structure element of the structure based on the first sensor data and third sensor data.

19. The system of claim 18, wherein the computer system further comprises:
a 3D reconstruction module configured to take as input the first sensor data and third sensor data and render a human-readable rendering of the structure.

20. The system of claim 19, wherein the third sensor is an RGBD sensor.
